(19) United States
(12) Patent Application Publication
(10) Pub. No.: US 2017/0011409 A1
(43) Pub. Date: Jan. 12, 2017

(54) SYSTEMS AND METHODS FOR DETECTING AND ELIMINATING UNAUTHORIZED DIGITAL COMMUNICATIONS

(71) Applicant: DNA Response Inc., Seattle, WA (US)

(72) Inventors: Thomas D. Eager, Bainbridge Island, WA (US); Joshua Ryan Nelson, Seattle, WA (US); Ranjit Muljaonkar, Bainbridge Island, WA (US); Thomas P. Maliska, JR., Olympia, WA (US)

(21) Appl. No.: 14/868,316

(22) Filed: Sep. 28, 2015

Related U.S. Application Data
(63) Continuation-in-part of application No. 13/670,367, filed on Nov. 6, 2012, now abandoned.

(51) Int. Cl. G06Q 30/02; G06F 17/30

(52) U.S. Cl. CPC G06Q 30/0201; G06F 17/30867; H04W 12/12

(57) ABSTRACT

Online communications are susceptible to high levels of fraud or other unauthorized communications. Online sources of information about goods, including business-to-business resources, marketplace web sites, custom retail web sites, and the like may knowingly or unknowingly transmit communications representing counterfeit goods as genuine, communications regarding overstock goods at low prices without production and commission costs, and solicit customers anonymously. In some embodiments of the present disclosure, electronic information sources are monitored using data metrics to track electronic retailer activities, monitor distribution volumes by source, and monitor pricing. Analysis of such communications may be used to detect potentially fraudulent activity, and, based on manufacturer policy and threshold settings, may automatically report, notify, or take action against such illicit communications.

### CROSS-REFERENCE TO RELATED APPLICATION

This application is a continuation-in-part of U.S. application Ser. No. 13/670,367, filed Nov. 6, 2012, the entire disclosure of which is hereby incorporated by reference herein for all purposes.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method for detecting and eliminating unauthorized digital communications is provided. Source profiles associated with a plurality of product sources are built. Building source profiles associated with a plurality of product sources comprises generating a set of search queries based on a set of product definitions; executing the set of search queries to obtain a set of gathered resources; creating a set of source profiles based on the set of gathered resources; and updating the set of source profiles with information retrieved from the set of gathered resources using a set of parsing rules. A determination is made regarding whether one or more aspects of a source profile of the set of source profiles exceed one or more predetermined remediation thresholds by calculating a presentation assessment score based on a comparison of brand information presented in the set of gathered resources used to create the source profile to brand information presentation guidelines identified in a product definition used to create the source profile. In response to determining that one or more aspects of the source profile exceed one or more predetermined remediation thresholds, a remediation workflow having one or more remediation steps is created; and the remediation steps of the remediation workflow are executed.

In some embodiments, a system for detecting and eliminating unauthorized digital communications is provided. The system comprises at least one computing device. Source profiles associated with a plurality of product sources are built by the at least one computing device. Building source profiles associated with a plurality of product sources comprises generating a set of search queries based on a set of product definitions; executing the set of search queries to obtain a set of gathered resources; creating a set of source profiles based on the set of gathered resources; and updating the set of source profiles with information retrieved from the set of gathered resources using a set of parsing rules. A determination is made by the at least one computing device regarding whether one or more aspects of a source profile of the set of source profiles exceed one or more predetermined remediation thresholds by calculating a presentation assessment score based on a comparison of brand information presented in the set of gathered resources used to create the source profile to brand information presentation guidelines identified in a product definition used to create the source profile. In response to determining that one or more aspects of the source profile exceed one or more predetermined remediation thresholds, a remediation workflow having one or more remediation steps is created by the at least one computing device; and the remediation steps of the remediation workflow are executed by the at least one computing device.

In some embodiments, a non-transitory computer-readable medium having computer-executable instructions stored thereon is provided. The instructions, in response to execution by one or more processors of one or more computing devices, cause the one or more computing devices to perform actions for detecting and eliminating unauthorized digital communications. Source profiles associated with a plurality of product sources are built. Building source profiles associated with a plurality of product sources comprises generating a set of search queries based on a set of product definitions; executing the set of search queries to obtain a set of gathered resources; creating a set of source profiles based on the set of gathered resources; and updating the set of source profiles with information retrieved from the set of gathered resources using a set of parsing rules. A determination is made regarding whether one or more aspects of a source profile of the set of source profiles exceed one or more predetermined remediation thresholds by calculating a presentation assessment score based on a comparison of brand information presented in the set of gathered resources used to create the source profile to brand information presentation guidelines identified in a product definition used to create the source profile. In response to determining that one or more aspects of the source profile exceed one or more predetermined remediation thresholds, a remediation workflow having one or more remediation steps is created; and the remediation steps of the remediation workflow are executed.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram that illustrates an overview of an exemplary embodiment of an approach to combating unauthorized online communications according to various aspects of the present disclosure;

FIG. 2 is a block diagram that illustrates components of an exemplary embodiment of a communication protection system according to various aspects of the present disclosure;

FIGS. 3A-3E include a flowchart that illustrates an exemplary embodiment of a method of monitoring online communications for potential unauthorized communications, according to various aspects of the present disclosure;

FIG. 4 illustrates an exemplary letter template that may be utilized by the automated remediation engine as part of a remediation action according to various aspects of the present disclosure;

FIGS. 5A-5C illustrate portions of an exemplary product definition usable by various components of the communication protection system according to various aspects of the present disclosure; and

FIG. 6 illustrates aspects of an exemplary computing device appropriate for use with embodiments of the present disclosure.

### DETAILED DESCRIPTION

The wide proliferation of online communication, by its nature, creates many channels for advertising, communications about goods and services, and transactions for goods and services. Such proliferation also magnifies the opportunities for unauthorized digital communications, including unauthorized digital communications about goods and services that may be referred to as online fraud, whether in the form of communications regarding grey market or black market goods, or simply unauthorized digital communications relating to the sale of otherwise authentic goods and services. A chasm has emerged between the capacity of business and legal systems to identify and correct these problems, thus reducing the effective return of online markets to participant manufacturers and service providers. The present disclosure proposes to engage as subscribers the manufacturers of goods sold online, and to automate the detection and handling of unauthorized digital communications for these subscribers to help reduce the impact of fraud. While the present disclosure refers to “manufacturers” and “products” for ease of discussion, one of skill in the art will recognize that “manufacturers” include any individual or entity that authorizes communications relating to a source of goods to the market, and “products” may include any goods and/or services that may be offered for sale online, such as those provided by manufacturers of goods, authorized distributors of goods, providers of services, authors or distributors of copyrighted materials, individuals, and/or the like.

In some embodiments of the present disclosure, sources of information are actively audited for potential online fraud and its contact points with consumers, such as via web pages, e-mail, online advertisements and e-coupons, and so forth. In such embodiments the discovery and investigation of unauthorized communications may be automated using techniques such as comparative pricing systems, information on known sources of goods from the manufacturers, access to spam and virus reporting systems, crowd-sourced information such as product and service reviews, and/or the like.

Some embodiments of the present disclosure may also identify—by specification or policy—thresholds for action by authorities such as manufacturers, e-commerce sites, or civil and police authorities; provide concise, accurate information supporting a decision framework for selecting an appropriate response by those authorities; provide consumers with information to avoid fraudulent sources and counterfeit goods by aggregating data and recommendations, or by certifying sources as approved by manufacturers and operating within limits of approval of transactions and satisfaction of customers established, by contract or policy, between the manufacturer of a product and its distributors; and/or the like.

The following description describes exemplary sources of information for evaluating online communications and identifying unauthorized communications relating to fraud; exemplary decision metrics and frameworks usable to establish policy for action when fraud is reported or detected; exemplary triggers for taking action on such fraud; and exemplary workflow methods for automating the delivery of information to those parties or authorities best suited to eliminate or deter such fraud.

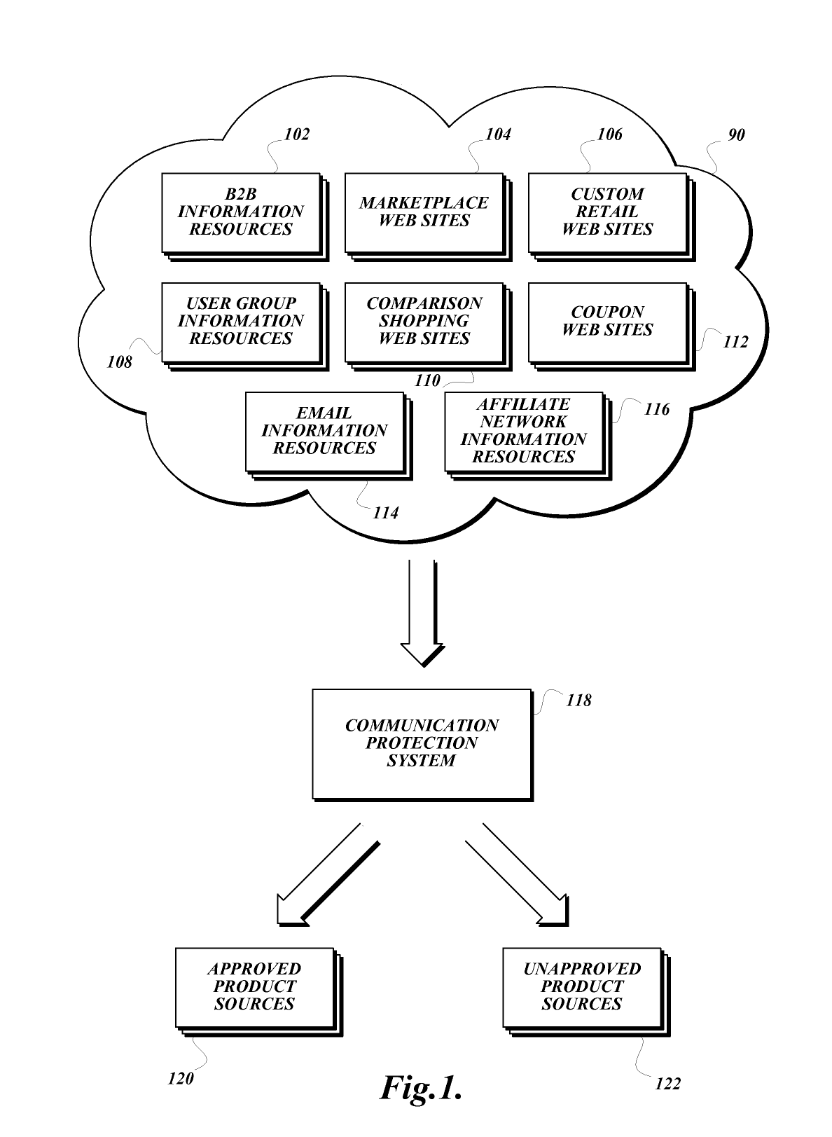

FIG. 1 is a schematic diagram that illustrates an overview of an exemplary embodiment of an approach to combating unauthorized online communications according to various aspects of the present disclosure. As the internet matures, manufacturers and distributors alike have deployed multiple ways to make products and information available to consumers. Such a set of online information resources is illustrated as being made available on the internet 90. Manually searching all of the sources on the internet 90 may not be practical, and may not provide assurance respecting the source of goods offered for sale. For example, searching on a web site of a merchant that sources goods from reputable distributors (e.g., the web site of a brick-and-mortar retailer such as Best Buy®, Macy's, and/or the like) provides some assurance as to the source of goods and reliability of the distributor, based on the reputation, service quality, and goodwill established by such merchants. However, searches of information resources that provide less controlled access to sellers (such as Amazon.com, shopping search engines, and/or the like) will likely yield wider sources for a product but will not provide reliable information about those who supply the goods. Accordingly, certain types of information resources may provide a greater risk of encountering counterfeits, unlicensed distributors, and/or other types of unauthorized communications, and may make it difficult to identify or shut down such communications.

As illustrated, information resources may, without limitation, include business-to-business (B2B) information resources 102, marketplace web sites 104, custom retail web sites 106, user group information resources 108, comparison shopping web sites 110, coupon web sites 112, email information resources 114, and affiliate network information resources 116. While many communications through such information resources are legitimate, each type of information resource is vulnerable for exploitation by parties attempting to distribute products or otherwise communicate without the authorization of the manufacturer. Each type of information resource may present products and/or product information in a different way, and may pose different challenges for monitoring for problematic product sales and/or communications.

A B2B information resource 102 may enable domestic companies to participate in international trade with a minimal investment. Examples of a B2B information resource 102 include, but are not limited to, Alibaba.com®, DHGate.com, Made-in-China.com, and the like. A B2B information resource 102 typically arranges sales of new goods from a foreign producer to a domestic reseller. B2B information resources 102 may provide a convenient way for international counterfeiters to export large volumes of product.

A marketplace web site 104 may allow companies and individuals to market and sell products without developing their own separate web presence. Examples of marketplace web sites 104 include, but are not limited to, Amazon.com, eBay, and the like. A marketplace web site 104 typically enables an indirect purchase where the marketplace web site 104 acts as a middle man that handles payments for new and/or used items. The marketplace web site 104 or the product source itself may ship the product to the customer.

A custom retail web site 106 that only offers communications regarding a few products (or even a single product) may be created by a product source. Temporarily creating and subsequently moving or removing a custom retail web site 106 is relatively easy for an unscrupulous product source to do, and because of this transient nature, custom retail web sites 106 are often difficult to track. Customers of such a web site may be unaware of where the custom retail web site 106 or associated product source is located. Landing pages and links in advertising may be changed rapidly, leaving customers without the purchased products or without other follow-up services. Some examples of legitimate custom retail web sites 106 include, but are not limited to, www.shavematetv.com, www.spacebag.com, and the like. Typical sales transactions with a custom retail web site 106 include a direct credit card purchase of new or refurbished items from the custom retail web site 106 by the customer.

User group information resources 108 often allow individuals with a common interest to share personal experiences in forums, blogs, and/or the like. While user group information resources 108 may not traditionally be thought of as online marketplaces, unscrupulous product sources may nevertheless target or use user group information resources 108 to drive unauthorized sales of products. Some examples of user group information resources 108 include, but are not limited to, bicycle clubs such as the Seattle Bicycle Club (www.seattlebicycleclub.org), wine clubs such as the Seattle Uncorked Wine Club (seattleuncorked.com), and the like. Typically, a product source may direct unadvertised offers to users of the user group information resources 108, such as through forum posts, blog comments, and/or the like. The product source may offer new or refurbished items.

Comparison shopping web sites 110 and coupon web sites 112 encourage price comparisons and provide discounts. These sites often do not themselves offer products for sale, but instead aggregate search results from other product sources to provide communications regarding product price information from multiple sources to users, who may then purchase the products from the product sources. Some examples of comparison shopping web sites 110 include, but are not limited to, PriceGrabber.com, Google Shopping, Shopzilla, and/or the like. Some examples of coupon web sites 112 include, but are not limited to, Groupon, Bloomspot, LivingSocial, and/or the like. Sometimes, unscrupulous product sources may be found and suggested to users by the comparison shopping web sites 110 due to their lower prices.

Email information resources 114 are often used to direct traffic to unscrupulous product sources. Such product sources often send mass amounts of unsolicited commercial email to potential customers to drive traffic to sources from which products may be obtained. Email information resources 114 may include the emails themselves, may include collections of customer inquiries related to or samples of unsolicited commercial emails, and/or may include data obtained by spam email analysis services. Affiliate network information resources 116 utilize private websites to advertise products for other companies. Affiliate network information resources 116 often specialize in particular product categories. For example, an affiliate network may offer a product source an avenue to distribute advertising to websites, while the affiliate network may offer websites compensation for displaying the advertising of the product source when a purchaser completes a specific action (such as completing a purchase and/or the like). Examples of affiliate network information resources 116 include, but are not limited to, Click2Sell, ClickBooth, and/or the like. A simple model for affiliate advertising networks involves product sources posting product or service information, and affiliates advertising those postings through other sites, banner ad placements, keyword-based search engine advertising, email campaigns, and/or the like. The affiliate network, acting as an intermediary, allows the product source and the affiliate to track click rates and/or purchases, and to share revenue from sales. The extra layer of abstraction between the customer and the product source make it difficult for the customer to identify counterfeits. Unscrupulous product sources may often exploit affiliate network information resources 116 using spam emails, banner advertising, and/or the like to direct traffic to their affiliate pages, and may leave customers without the purchased products or without follow-up services.

One of ordinary skill in the art will recognize that more types of information resources may be available on the internet 90 or elsewhere, and also that techniques similar to those described herein with respect to the illustrated types of information resources may also be used with respect to information resource types that are not explicitly illustrated or described herein.

In some embodiments of the present disclosure, a communication protection system 118 is provided. The communication protection system 118 is configured to search and analyze the information resources on the internet 90 in an automated matter in order to monitor all online sources for product sale offerings. The communication protection system 118 may be configured to automatically categorize product sources on the internet 90 into approved product sources 120 and unapproved product sources 122. Depending on a type of an unapproved product source 122, the communication protection system 118 may flag the product source for additional monitoring, may transmit a notification to the manufacturer, may perform automated actions to shut down the product source, and/or the like. Such actions may be taken by the communication protection system 118 in response to detecting a pattern of online communication for a product that triggers an alert or matches thresholds established by the manufacturer, such as the detection of an unlicensed distributor, the detection of irregular transactions, the detection of counterfeit advertising, and/or the like. In some embodiments, the communication protection system 118 may use data mining techniques and secure access to information respecting online communications to provide coverage of potential counterfeit channels in advance of illegal or unwanted communication activity. In some embodiments, the communication protection system 118 may provide information to the manufacturer and/or the product source for the efficient negotiation of commercially acceptable terms, for informed civil or criminal prosecution, or for the regular enforcement of manufacturer policies for communication regarding its products online.

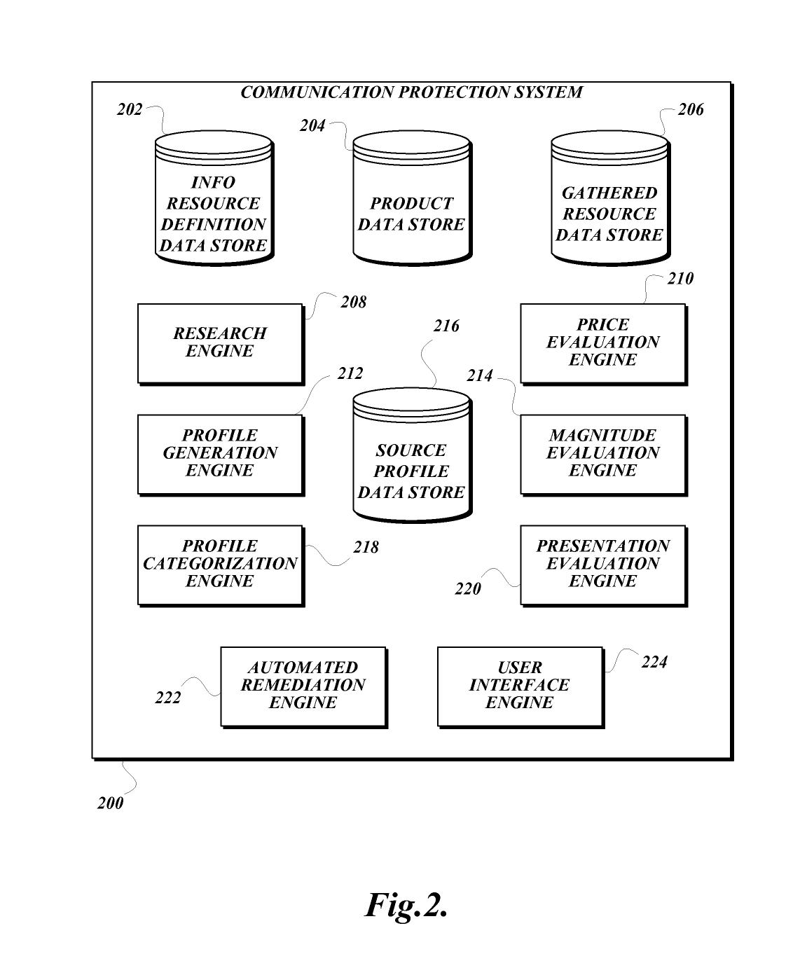

FIG. 2 is a block diagram that illustrates components of an exemplary embodiment of a communication protection system 200 according to various aspects of the present disclosure. As illustrated, the communication protection system 202 includes an information resource definition data store 202, a product data store 204, a gathered resource data store 206, and a source profile data store 216. As understood by one of ordinary skill in the art, a “data store” as described herein may include any suitable device configured to store data for access by a computing device. One example of a data store is a highly reliable, high-speed relational database management system (DBMS) executing on one or more computing devices and accessible over a high-speed packet switched network. However, any other suitable storage technique and/or device capable of quickly and reliably providing the stored data in response to queries may be used, and the computing device may be accessible locally instead of over a network, or may be accessible over some other type of suitable network or provided as a cloud-based service. A data store may also include data stored in an organized manner on a storage medium 608, as described further below. One of ordinary skill in the art will recognize that separate data stores described herein may be combined into a single data store, and/or a single data store described herein may be separated into multiple data stores, without departing from the scope of the present disclosure.

In some embodiments, the information resource definition data store 202 includes a plurality of definition records associated with a plurality of information resources. In some embodiments, the definition records may include a definition of an information resource, including an indication of the type of the information resource, a name of the information resource, contact information associated with the information resource, information regarding how to extract product information from the information resource, and/or the like. In some embodiments, the product data store 204 may include a plurality of records associated with products to be monitored by the communication protection system 200. The product records may include information provided by the product manufacturers to help monitor information resources for sales of the products, including product names, search terms likely to find instances of communications regarding the products, pricing information associated with the products, sales volume information associated with the products, and/or the like. In some embodiments, the gathered resource data store 206 may include a plurality of gathered resource records that indicate sales or other online communication activities associated with the products as detected by the communication protection system 200. In some embodiments, the source profile data store 216 may include a plurality of source profiles that store information about each of the detected product sources and analysis thereof performed by the communication protection system. The analysis may include, without limitation, authenticating licensed distributors, identifying unknown distributors, examining trademark usage and branding, evaluating pricing, and/or the like. The source profiles and the analysis thereof are discussed further below.

As illustrated, the communication protection system 200 also includes a research engine 208, a price evaluation engine 210, a profile generation engine 212, a magnitude evaluation engine 214, a profile categorization engine 218, a presentation evaluation engine 220, an automated remediation engine 222, and a user interface engine 224. In general, the word “engine” as used herein, refers to logic embodied in hardware or software instructions. The instructions may be written in an object oriented programming language, such as C++, JAVA™, C#, and/or the like; procedural programming languages, such as C, Pascal, Ada, Modula, and/or the like; functional programming languages, such as ML, Lisp, Scheme, and the like; scripting languages such as Perl, Ruby, Python, JavaScript, VBScript, and the like, declarative programming languages such as SQL, Prolog, and/or the like; or in any other type of programming language. An engine may be compiled into executable programs or executed as an interpreted programming language. Engines may be callable from other engines or from themselves. Generally, the engines or applications described herein refer to logical modules that can be merged with other engines or applications, or can be divided into sub-engines. The engines can be stored in any type of computer-readable medium or computer storage device and be stored on and executed by one or more general purpose computers, thus creating a special purpose computer configured to provide the engine. A single computing device may be configured to perform the functionality described in one or more engines, and/or the functionality of one or more engines may be split between multiple computing devices using any one of a variety of structuring techniques known in the art, including without limitation multiprocessing, client-server processing, peer-to-peer processing, grid-based processing, cloud-based processing, and/or the like.

In some embodiments, the research engine 208 is configured to build queries for product sources based on product records from the product data store 204, and to store raw gathered resources in the gathered resource data store 206. In some embodiments, the profile generation engine 218 is configured to process the gathered resources from the gathered resource data store 206 to create profiles of detected product sources, and to store the profiles in the source profile data store 216. In some embodiments, the price evaluation engine 210, the magnitude evaluation engine 214, and the presentation evaluation engine 220 are configured to review the source profiles in the source profile data store 216, and to analyze pricing information, sales volume information, and product presentation information, respectively. In some embodiments, the profile categorization engine 218 is configured to review the analysis of the source profiles, and to assign categories to each source profile that determine further actions to be taken with respect to each source profile. In some embodiments, the automated remediation engine 222 is configured to take automatic actions with respect to particular categories of source profiles to help remediate unauthorized product sources in those particular categories. In some embodiments, the user interface engine 224 is configured to provide one or more user interfaces for interacting with the communication protection system 200, including at least one interface configured to allow product manufacturers to specify products to be monitored, to review product presentation information, to take manual remediation actions with respect to particular categories of source profiles, and to view aggregated information collected by the communication protection system 200 about the overall market for products. In some embodiments, the user interface engine 224 may also be configured to provide one or more application programming interfaces (APIs) for providing programmatic access to functionality of the communication protection system 200. Further details of the configurations of each of these engines are described below.

One of ordinary skill in the art will recognize that the components of the communication protection system 200 illustrated and described herein are exemplary only, and that in some embodiments, more or fewer components may be included, and/or the functionality described as associated with a given component may be provided by a different component or in conjunction with a different component. One of ordinary skill in the art will also recognize that the functionality of the communication protection system 200 may be provided by a single computing device or multiple computing devices communicatively coupled to each other via a local area network, a wide area network, or using any other suitable technology.

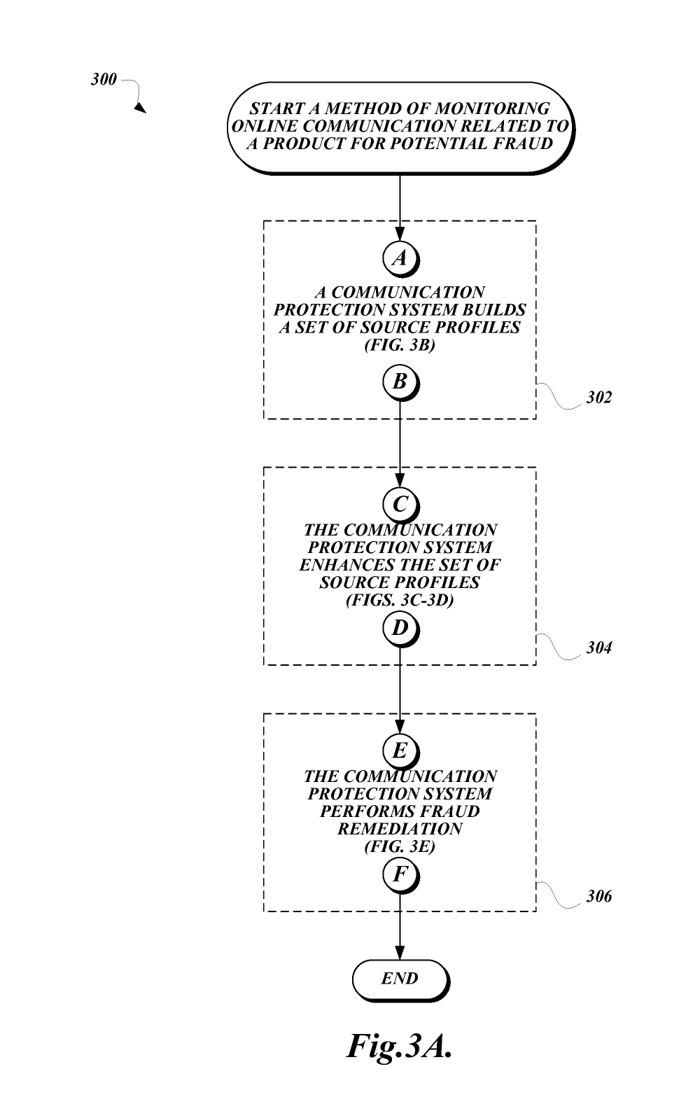

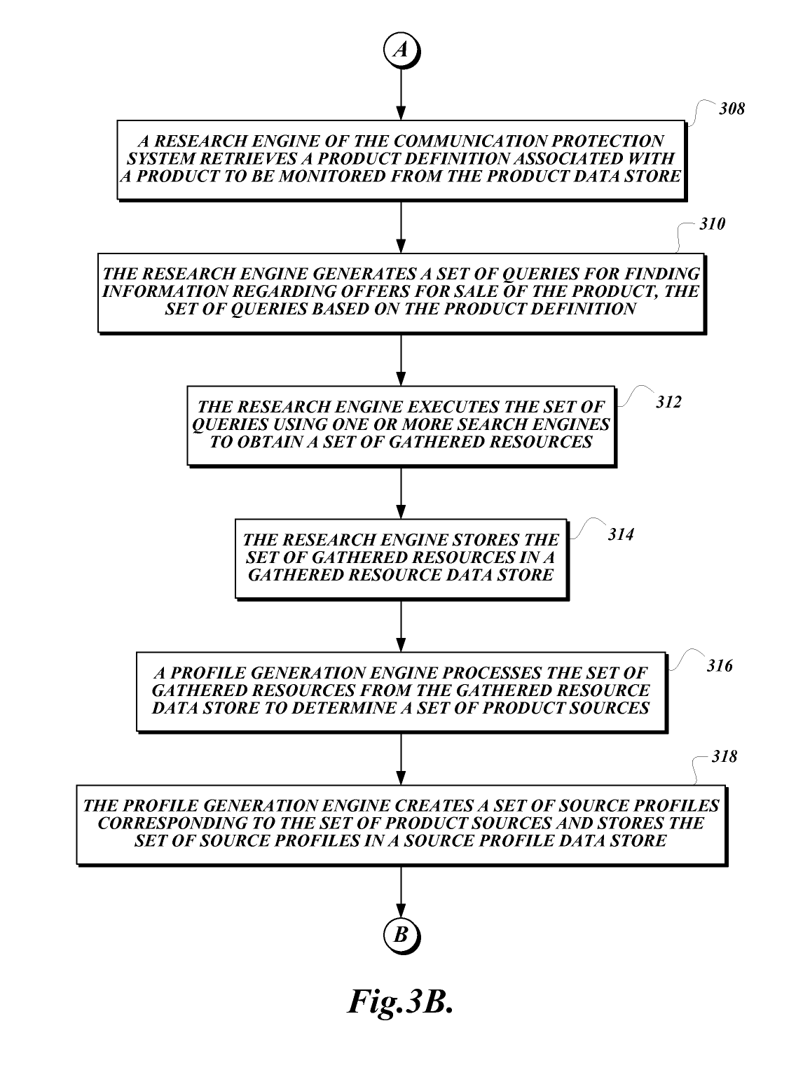

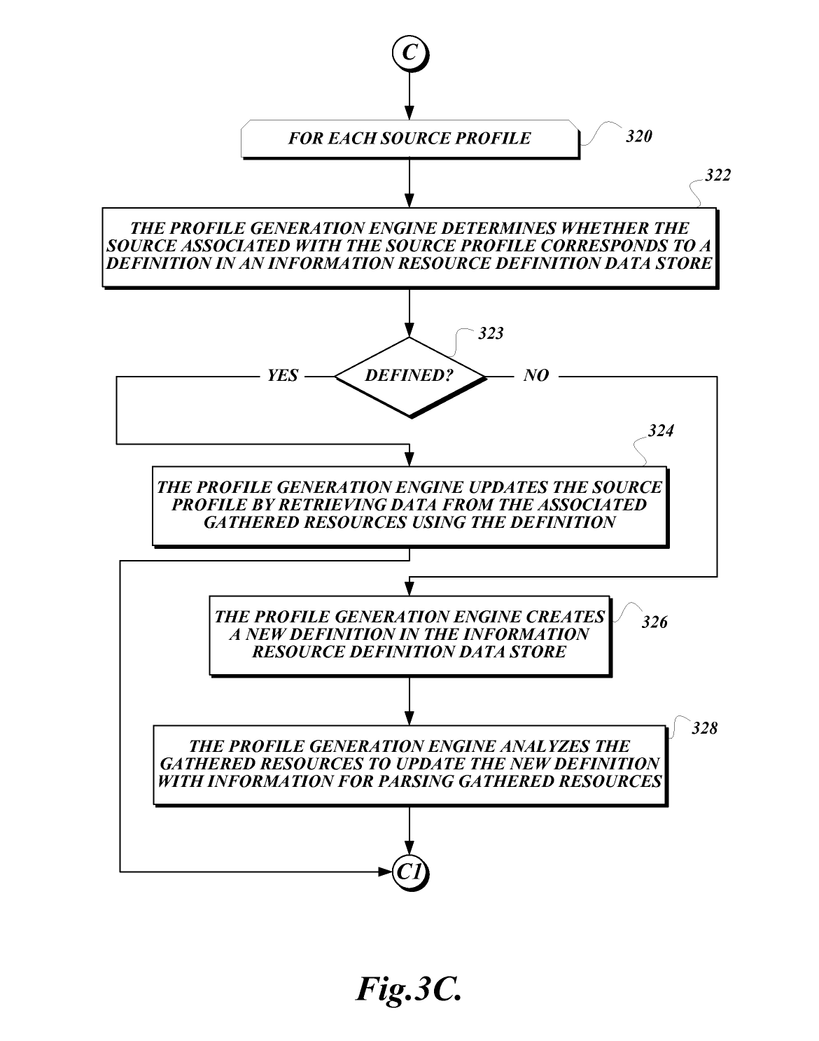

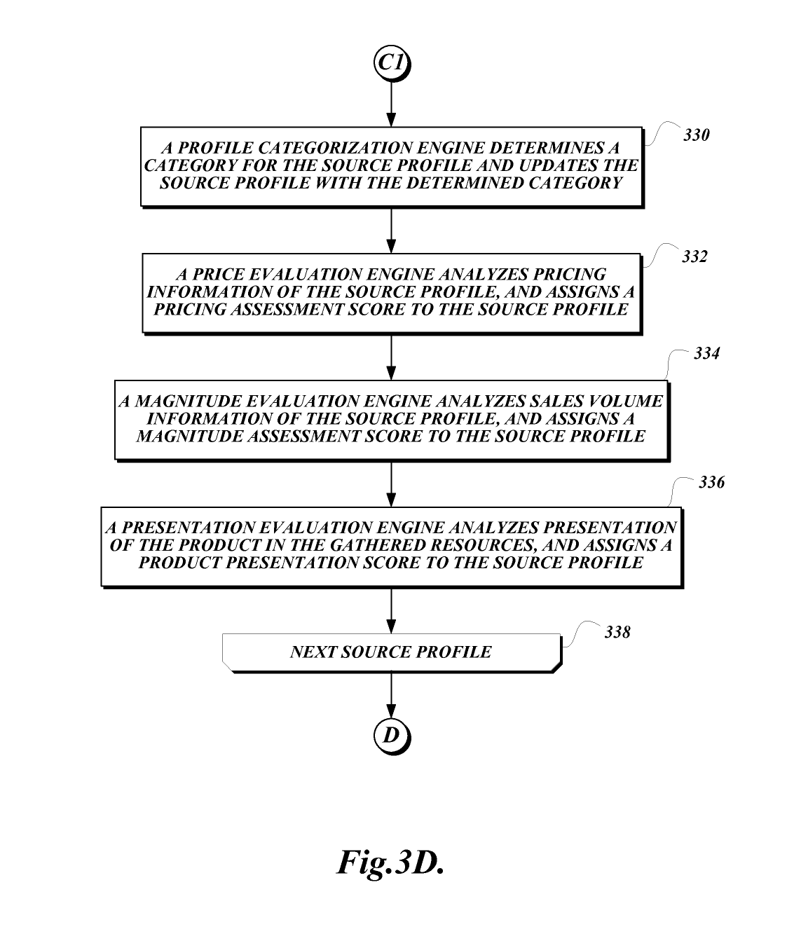

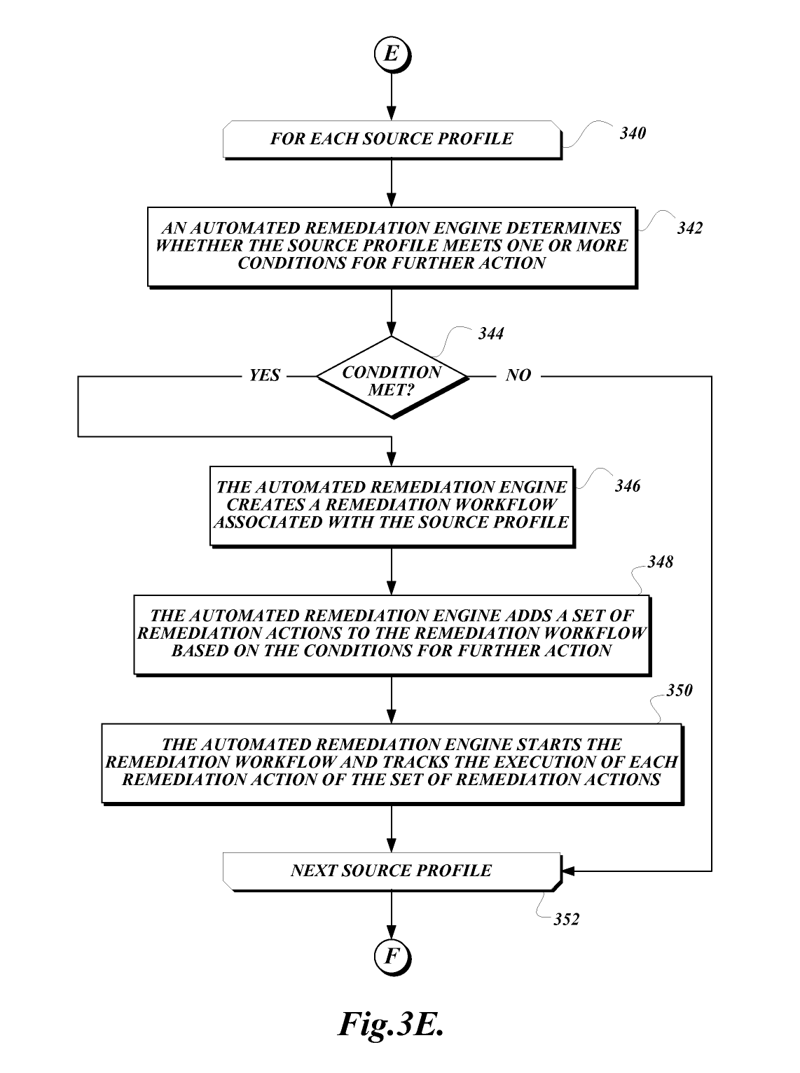

FIGS. 3A-3E include a flowchart that illustrates an exemplary embodiment of a method 300 of monitoring online communication related to a product for potential fraud, according to various aspects of the present disclosure. The method 300 is illustrated and described herein as relating to monitoring of communication related to a single product provided by a single manufacturer for ease of discussion. One of ordinary skill in the art will recognize that, in some embodiments, the method 300 may be performed for a plurality of related or unrelated products, from a plurality of related or unrelated manufacturers, without departing from the scope of the present disclosure. From a start block, the method 300 proceeds to a set of method steps 302 defined between a start terminal (“terminal A”) and an exit terminal (“terminal B”) wherein a communication protection system 200 builds a set of source profiles. From terminal A (FIG. 3B), the method 300 proceeds to block 308, where a research engine 208 of the communication protection system 200 retrieves a product definition associated with a product to be monitored from the product data store 204. In some embodiments, the product definition is created by the manufacturer via an interface generated by the user interface engine 224, and includes information usable by the communication protection system 200 to determine how to monitor the product. In some embodiments, the product definition may also include one or more preferences regarding product sources to monitor, whitelist/greylist/blacklist information for categorizing previously identified product sources, preferences relating to automated remediation steps to be taken by the communication protection system 200, expected pricing and volume information, and/or the like.

Next, at block 310, the research engine 208 generates a set of queries for finding information regarding offers for sale of the product, the set of queries based on the product definition. In some embodiments, the queries may be stored in the product definition, and retrieved by the research engine 208. In some embodiments, the research engine 208 may automatically generate queries for one or more search engines based on the information stored in the product definition (such as product or manufacturer names, associated trademarks or brand names, model numbers, product images, relevant date ranges, and/or the like).

At block 312, the research engine 208 executes the set of queries using one or more search engines to obtain a set of gathered results. One of ordinary skill in the art will recognize that the one or more search engines may include general search engines such as Bing (provided by Microsoft Corporation), Google (provided by Google, Inc.), and/or the like; search engines integrated into information resources (such as search functionality provided within Amazon.com, Alibaba.com, and/or the like); or any other type of search engine. In some embodiments, the research engine 208 may obtain gathered results from sources not traditionally thought of as search engines as discussed above but that are nevertheless usable to retrieve gathered results, including, but not limited to, web service APIs (e.g., to access information about merchant and user activity on Amazon services and/or the like), automated direct inspection of web sites (such as web crawler or spider programs that navigate a site automatically to copy or extract information and/or the like), archives of specific user activity (such as databases of ad banners or unsolicited bulk commercial email (“spam”)), and/or the like. The set of queries may be executed by the research engine 208 in series, in parallel, or in any other suitable manner. Next, at block 314, the research engine stores the set of gathered resources in a gathered resource data store 206. In some embodiments, each gathered resource may be a search result from a query, without having undergone further processing by the research engine 208. In some embodiments, each gathered resource may be a retrieved copy of the resource referenced by a search result from a query, without having undergone further processing by the research engine 208.

The method 300 then proceeds to block 316, where a profile generation engine 212 processes the set of gathered resources from the gathered resource data store 206 to determine a set of product sources. In some embodiments, each product source may correspond to an information resource offering the product for sale. In some embodiments, multiple product sources may be associated with a single information resource. For example, separate product sources may be determined for each distributor offering the product for sale on Alibaba.com or Amazon.com. At block 318, the profile generation engine 212 creates a set of source profiles corresponding to the set of product sources, and stores the set of source profiles in a source profile data store 216. One of ordinary skill in the art will recognize that, in some embodiments, the actions described with respect to block 314 may be optional, and the source profiles may be determined by the profile generation engine 212 directly from the resources gathered by the research engine 208 without the intermediate step of storing the gathered resources in the gathered resource data store 206. The method 300 then proceeds to terminal B.

From terminal B (FIG. 3A), the method 300 proceeds to a set of method steps 304 defined between a start terminal (“terminal C”) and an exit terminal (“terminal D”), wherein the communication protection system 200 enhances the set of source profiles. From terminal C (FIG. 3C), the method 300 proceeds to a for loop start block 320. The method 300 loops between the for loop start block 320 and a for loop end block 338 (FIG. 3D) to repeat the steps included therebetween for each source profile stored in the source profile data store 216. The “for loop” construct is used herein for ease of discussion only. One of ordinary skill in the art will recognize that, in some embodiments, the method 300 may process less than all of the source profiles stored in the source profile data store 216. For example, the method 300 may only process a set of source profiles stored in the source profile data store 216 that have been changed since a previous execution of some portion of the method 300. As another example, the method 300 may process any other subset of source profiles stored in the source profile data store 216, chosen for any reason. One of ordinary skill in the art will also recognize that, in some embodiments, a logic construct other than a “for loop” may be used to process the source profiles.

From the for loop start block 320, the method 300 proceeds to block 322, where the profile generation engine 212 determines whether the source associated with the source profile corresponds to an information resource definition in an information resource definition data store 202. At decision block 323, a test is performed based on the determination whether the source associated with the source profile corresponds to an information resource definition, and is therefore defined. If the answer to the test at decision block 323 is YES, the method 300 proceeds to block 324, where the profile generation engine 212 updates the source profile by retrieving data from the associated gathered resources using the definition of the information resource. In some embodiments, the definition of the information resource includes instructions for obtaining particular pieces of information from the associated gathered resources, such as pricing information, volume information, distributor names, product images, product descriptions, titles, contact information, advertised payment methods, and/or the like. In some embodiments, the definition of the information resource may include parsing rules that describe the expected format of the associated gathered resources and/or otherwise enable the profile generation engine 212 to obtain the particular pieces of information from the associated gathered resources. In some embodiments, the profile generation engine 212 may be configured to retrieve particular pieces of information without the benefit of parsing rules, such as by using default assumptions for particular types of content (e.g., larger than normal text may be considered a title, numeric strings with currency characters (“$”, “ [symbol] ”, “£”, “¥”, etc.) may be considered pricing information, and/or the like). However, if parsing rules are included in the definition of the information resource, it may provide greater confidence in the accuracy of the data retrieved from the associated gathered resources. From block 324, the method 300 proceeds to a continuation terminal (“terminal C1”).

Otherwise, if the result of the test at decision block 323 is NO, then the method 300 proceeds to block 326, where the profile generation engine 212 creates a new information resource definition in the information resource definition data store. At block 328, the profile generation engine 212 analyzes the gathered resources using default parsing rules to look for information in the gathered resources such as pricing information, volume information, distributor names, product images, and/or the like. The profile generation engine 212 then updates the source profile with the information obtained by the default parsing rules. In some embodiments, the new information resource definition may be flagged for review by an administrator, so that for future executions of the method 300, parsing rules may be created for more reliable collection of data from the information resource. The method 300 then proceeds to a continuation terminal (“terminal C1”).

From terminal C1 (FIG. 3D), the method 300 proceeds to block 330, where a profile categorization engine 218 determines a category for the source profile and updates the source profile with its assigned category. Categories may be based on categorization information included in the product definition, such as the whitelist/greylist/blacklist information described above. These lists may specify product sources based on a distributor associated with the product source, a combination of a distributor associated with the product source and an information resource (or information resource type) associated with the product source, and/or by any other suitable means. For example, assignment to the whitelist may be based on known distributors (the distributor information is available in the source profile), sale of original goods, pricing within an allowable range, a manufacturer approved market, and/or the like. As another example, assignment to the greylist may be based on a lack of distributor information in the source profile), a lack of manufacturing source information in the source profile, pricing outside of the allowable range, a lack of information regarding the identity of the source of payment processing or order fulfillment, a detection of counterfeit goods in mainstream commerce, a distributor or seller that is known to not be authorized to distribute or sell a product, a detection of stolen or overrun goods in the market, and/or the like.

Categorization of a source profile on the whitelist may indicate that the source profile is associated with a legitimate source of the product. Categorization of a source profile on the greylist, the blacklist, or an unknown list may indicate that the source profile should be analyzed further by the system to determine whether it is associated with a legitimate source or an illegitimate source for the product.

In some embodiments, assignment to a whitelist category may allow a product source to be identified with a certification mark or other indicator associated with the communication protection system 200. The indicator may be added to information resources advertising or listing products, such as advertisements, affiliate listings, e-commerce catalog pages, shopping carts, electronic coupons, and/or the like, indicating that a product is from a product source known and approved by the manufacturer (e.g., a licensed distributor). In some embodiments, indicators may also be provided to indicate that a product source is associated with the greylist category, the blacklist category, or an unknown category. The indicator may be provided to a customer by the communication protection system 200 without involvement of the associated information resource, in order to provide security, authority, and reliability to the indicator.

At block 332, a price evaluation engine 210 analyzes pricing information of the source profile, and assigns a pricing assessment score to the source profile. In some embodiments, the pricing assessment score may be based on a simple comparison of price information in the product definition to price information associated with the source profile. For example, the source profile may indicate that the product is being offered for sale at $10/unit. The product definition may indicate that the minimum advertised price for the product is $20/unit. The pricing assessment score may be based on this difference between the offer price and the minimum advertised price.

In some embodiments, the price evaluation engine 210 may perform further analysis of the total market for the product to determine the pricing assessment score, instead of simply comparing the price information to expected price information. For example, the price evaluation engine 210 may determine the pricing assessment score based on a magnitude of a deviation of an offer price associated with the source profile from a price basis determined for the overall market. The price evaluation engine 210 may determine the price basis based on one or more of a statistical measure (such as a mean, median, or mode of prices from all source profiles), a comparison to a minimum advertised price specified in the product definition, a comparison to a recommended retail price specified in the product definition, a comparison to a custom target price, and/or any other value suitable for use as a price basis. The price evaluation engine 210 may determine the size of the deviation based on one or more of a statistical measure (such as a standard deviation, an average absolute deviation, and/or the like), a price difference (such as a percentage difference from the price basis, an absolute difference from the price basis, and/or the like), and/or any other comparison suitable for determining the size of the deviation. The pricing assessment score will then be assigned based on this comparison. The use of pricing assessment scores instead of explicit price comparisons or thresholds may be beneficial, at least because the price evaluation engine 210 may use different characteristics, different thresholds, and/or different comparisons for each source profile, but will nevertheless be able to compare the pricing assessment scores of source profiles even if they were not evaluated in the same way.

At block 334, a magnitude evaluation engine 214 analyzes sales volume information of the source profile, and assigns a magnitude assessment score to the source profile. The magnitude assessment score assigned by the magnitude evaluation engine 214 represents possible volume impact associated with the source profile on the overall market for the product. The magnitude evaluation engine 214 may consider availability for purchase (e.g., whether the product is indicated as being in stock, how many units are indicated as being in stock, and/or the like), minimum purchase required, and/or other factors in determining the magnitude assessment score. In some embodiments, the magnitude evaluation engine 214 may consider historical information stored within the source profile to consider volume and/or pricing information for the product source over time when determining the magnitude assessment score. In some embodiments, the magnitude evaluation engine 214 may be configured to consider more than one source profile at a time when determining the magnitude assessment score. For example, the magnitude evaluation engine 214 may consider multiple source profiles associated with a single seller—such as a source profile for an Amazon marketplace page, a separate source profile for an Alibaba product page, and another separate source profile for a custom web site—to determine the possible volume impact of the seller regardless of the particular source profile being evaluated. Accordingly, the magnitude assessment score for a given source profile may show a greater severity of impact than would otherwise be determined by its contents alone if other source profiles show that a seller associated with the given source profile has an impact on the overall market from multiple information resources. In some embodiments, the magnitude evaluation engine 214 may infer sales volumes for a product source based on other available information when sales volume information is not directly available. For example, the magnitude evaluation engine 214 may infer a sales volume based on a number of product reviews posted on a product detail page.

At block 336, a presentation evaluation engine 220 analyzes presentation of the product in the gathered resources, and assigns a product presentation score to the source profile. In some embodiments, the presentation evaluation engine 220 may perform automated analysis of how the product is presented by the product source. In some embodiments, the presentation evaluation engine 220 may cause the user interface engine 224 to present an interface to a user to manually review the presentation of the product by the product source. In some embodiments, the analysis performed by the presentation evaluation may include comparison of images of the product to a set of approved images; presence or absence of taglines or other promotional copy; presence or absence of trademarks associated with the product or manufacturer; quality of presentation (e.g., misspellings, font choices, and/or the like); colors; placement of promotional text, taglines, trademarks, and/or the like; presence of look-alike products; and/or any other suitable aspect of the presentation of the product. The determined product presentation score may then indicate whether the product is being presented properly (and is therefore more likely to be associated with a legitimate product source), or whether the product is being presented improperly (and is therefore more likely to be associated with an illegitimate product source).

The method 300 then proceeds to the for loop end block 338. If there are further source profiles to be processed, the method 300 returns to the for loop start block 320. Otherwise, the method 300 proceeds to a continuation terminal (“terminal D”).

From terminal D (FIG. 3A), the method 300 proceeds to a set of method steps 306 defined between a start terminal (“terminal E”) and an exit terminal (“terminal F”), wherein the communication protection system 200 performs fraud remediation. From terminal E (FIG. 3E), the method 300 proceeds to a for loop start block 340. The method 300 loops between the for loop start block 340 and a for loop end block 352 to repeat the steps included therebetween for each source profile stored in the source profile data store 216. As with the previously illustrated “for loop,” the “for loop” construct is used herein for ease of discussion only. One of ordinary skill in the art will recognize that, in some embodiments, the method 300 may process less than all of the source profiles stored in the source profile data store 216. For example, the method 300 may only process a set of source profiles stored in the source profile data store 216 that have been changed since a previous execution of some portion of the method 300, or a set of source profiles stored in the source profile data store 216 in a particular category as assigned by the profile categorization engine 218, or meeting particular thresholds for one or more of the pricing assessment score, the magnitude assessment score, or the presentation assessment score. As another example, the method 300 may process any other subset of source profiles stored in the source profile data store 216, chosen for any reason. One of ordinary skill in the art will also recognize that, in some embodiments, a logic construct other than a “for loop” may be used to process the source profiles.

From the for loop start block 340, the method 300 proceeds to block 342, where an automated remediation engine 222 determines whether the source profile meets one or more conditions for further action. In some embodiments, the conditions for further action may include individual trigger controls and/or combined threat assessments. Individual trigger controls may be configurable to cause further action based on particular conditions. One example of an individual trigger control may cause further action based on a category assigned to the source profile. For example, such an individual trigger control may cause further action for source profiles categorized in a blacklist, while ignoring source profiles categorized in a greylist or a whitelist.

Another example of an individual trigger control may cause further action based on a threshold for one or more values in the source profile. For example, such an individual trigger control may cause further action if a pricing assessment score is greater than or less than a predetermined value, if the magnitude assessment score is greater than or less than a predetermined value, if the presentation assessment score is greater than or less than a predetermined value, or any other suitable threshold for any other suitable value or combinations of values. Such thresholds may be configurable based on different types of product sources, and/or may be configurable based on particular information resources. For example, a pricing assessment threshold that causes further action may be higher for a generally more reputable information resource (e.g., Amazon.com) than for a generally less reputable information resource (e.g., eBay or Craigslist), even though both may be the same type of information resource. Likewise, such thresholds may be configurable for different categories of source profiles and/or for any other suitable reason.

As stated above, the conditions for further action may include combined threat assessments. In some embodiments, a combined threat assessment may be a combined score that helps to measure the overall scope of illegitimate products in the supply chain. This scope may be determined using information from a combination of information used within the individual trigger controls described above. For example, a given product source may have a pricing assessment score that is slightly high, a magnitude assessment score that is slightly high, and a presentation assessment score that is slightly high. None of these scores may individually be high enough to trigger any of the individual trigger controls, but the scores may be combined to show an overall threat assessment that warrants further action.

The method 300 then proceeds to a decision block 344, where a test is performed to determine whether one or more of the conditions for further action have been met. If the result of the test at decision block 344 is NO, then the method 300 proceeds to the for loop end block 352. Otherwise, if the result of the test at decision block 344 is YES, then the method 300 proceeds to block 346, where the automated remediation engine 346 creates a remediation workflow associated with the source profile. Data representing the created remediation workflow may be stored within the source profile itself, elsewhere in the source profile data store 216, or in any other suitable location. At block 348, the automated remediation engine 222 adds a set of remediation actions to the remediation workflow based on the conditions for further action. Remediation actions may include, but are not limited to, sending of notifications, establishing watch conditions, presenting data for legal action, and presenting assessment reports.

Notifications may include email notifications to the product source or information resource that include notice of the illicit communication and/or request further information. Notifications may also include legal letters. Many types of legal action and related communications may be possible. The particular type of legal action added to the remediation workflow may be determined based on the severity of the impact of the product source on the market for the product. Watch conditions may include performing test purchases to help reveal payment sources, reveal party information, enable inspection of goods, establish venue, and/or the like. Watch conditions may also include determining a new whitelist/greylist/blacklist category for the product source. When collecting and/or presenting data for legal action, the automated remediation engine 222 may collect or provide sample communications, exhibits of the actual product, exhibits of standard advertising vs. advertising by the product source, exhibits of the party communication, exhibits of standard pricing vs. pricing by the product source, and/or the like. Assessment reports may include charts of where the analyzed source profile falls with respect to pricing, magnitude, and/or the like with respect to other legitimate or illegitimate source profiles.

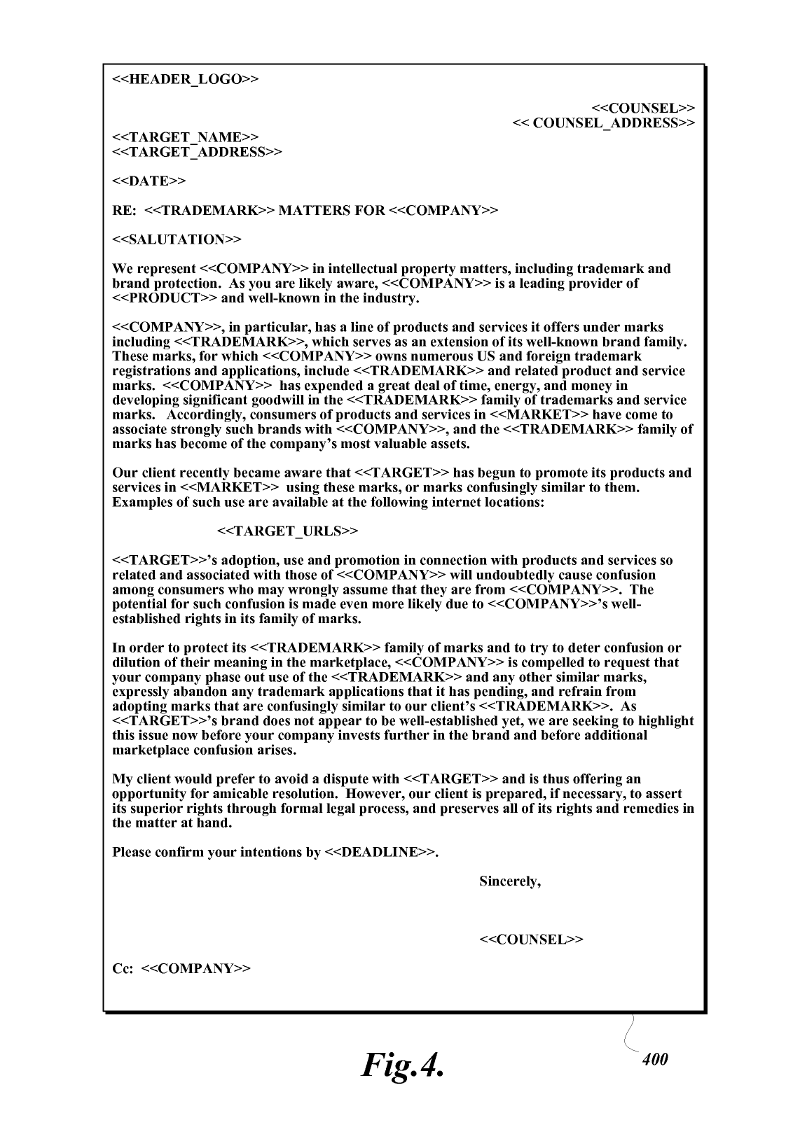

FIG. 4 illustrates an exemplary letter template that may be utilized by the automated remediation engine 222 as part of a remediation action according to various aspects of the present disclosure. The exemplary letter template 400 may be used upon the detection of communication related to goods being distributed under a brand confusingly similar to a monitored trademark. The letter template 400 includes a set of variable values (indicated in the drawing as delimited by angle brackets and in all caps, such as <<TARGET_NAME>>, <<TARGET_ADDRESS>>, <<TARGET_URLS>>, etc.) to be merged or otherwise automatically completed with appropriate values by the automated remediation engine 222 based on the results of investigation and automated data mining. A letter automatically created based on the letter template 400 may be reviewed and approved for delivery by counsel or the manufacturer via an interface provided by the user interface engine 224. Similar letter templates may be prepared and letters automatically generated to provide notification of copyright infringement, trademark/branding infringement or misuse, patent infringement, violation of distribution agreements, and/or any other suitable notification. In some embodiments, reports providing factual bases for legal pleadings (or the legal pleadings themselves) may be generated by the automated remediation engine 222 in a similar manner. Various software tools or engines for creating the merged documents based on such templates are available in the art, including, but not limited to, word processor merge features, web form merges, PDF form merges, variable data printing, email merge, database report generators, and/or the like. In some embodiments, the automated remediation engine 222 may similarly create and transmit notices to e-commerce providers, online payment providers, affiliate networks, and/or the like, respecting detected fraudulent activity on the part of a user of or participant in such information resources.

In some embodiments, the conditions for further action may be used to determine the severity of the remediation actions added to the remediation workflow. For example, if a threshold based on the pricing assessment score was crossed but a threshold based on the magnitude assessment score was not crossed, the automated remediation engine 222 may add a remediation action that includes sending a notification to the manufacturer to indicate that the manufacturer may wish to investigate the product source further, or a remediation action that includes further automatic investigation such as performing test purchases and/or the like. As another example, if the threshold based on the pricing assessment score was crossed and the threshold based on the magnitude assessment score was also crossed, the automated remediation engine 222 may add a remediation action that includes automatically sending a takedown notice, automatically generating documents to be transmitted to the relevant authorities, and/or the like.

At block 350, the automated remediation engine 222 starts the remediation workflow and tracks the execution of each remediation action of the set of remediation actions. In some embodiments, the remediation actions may be performed by the automated remediation engine 222 itself (such as automatically transmitting takedown requests, automatically generating legal documents, and/or the like). In some embodiments, the remediation actions may be enabled by the automated remediation engine 222, but may be performed or completed manually. For example, the automated remediation engine 222 may flag a source profile for review, and may then present the source profile to the manufacturer via an interface generated by the user interface engine 224 for further manual review. As another example, the automated remediation engine 222 may create assessment reports relating to the source profile, and may then present the assessment reports to the manufacturer via an interface generated by the user interface engine 224 for further manual review. The remediation workflow may continue until the product source is effectively remediated, until all workflow actions have been completed regardless of whether the product source has been effectively remediated, or until any other suitable end point.

The method 300 then proceeds to the for loop end block 352. If there are further source profiles to be processed, the method 300 returns to the for loop start block 340. Otherwise, the method 300 proceeds to a continuation terminal (“terminal F”). From terminal F (FIG. 3A), the method 300 proceeds to an end block and terminates.

As will be appreciated by one skilled in the art, the specific routines described above in the flowcharts may represent one or more of any number of processing strategies such as event-driven, interrupt-driven, multi-tasking, multi-threading, and the like. As such, various acts or functions illustrated may be performed in the sequence illustrated, in parallel, or in some cases omitted. Likewise, the order of processing is not necessarily required to achieve the features and advantages, but is provided for ease of illustration and description. Although not explicitly illustrated, one or more of the illustrated acts or functions may be repeatedly performed depending on the particular strategy being used. Further, these FIGURES may graphically represent code to be programmed into a computer readable storage medium associated with a computing device.

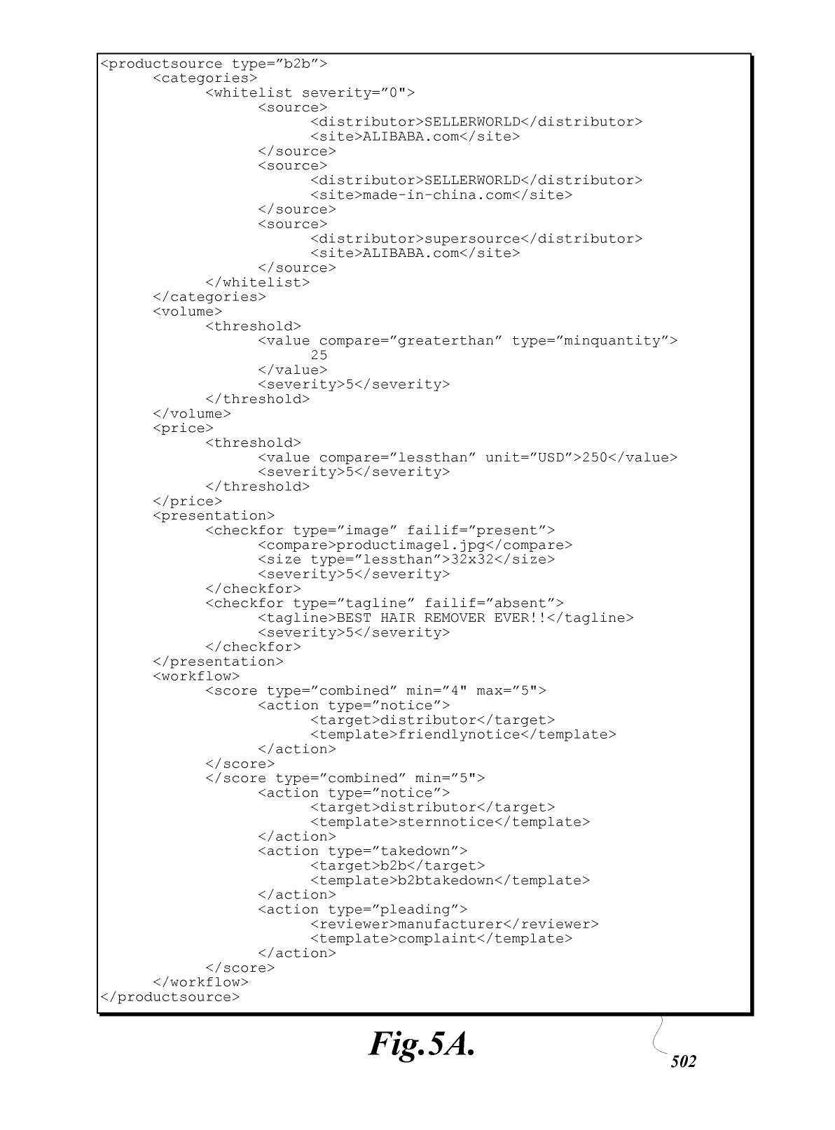

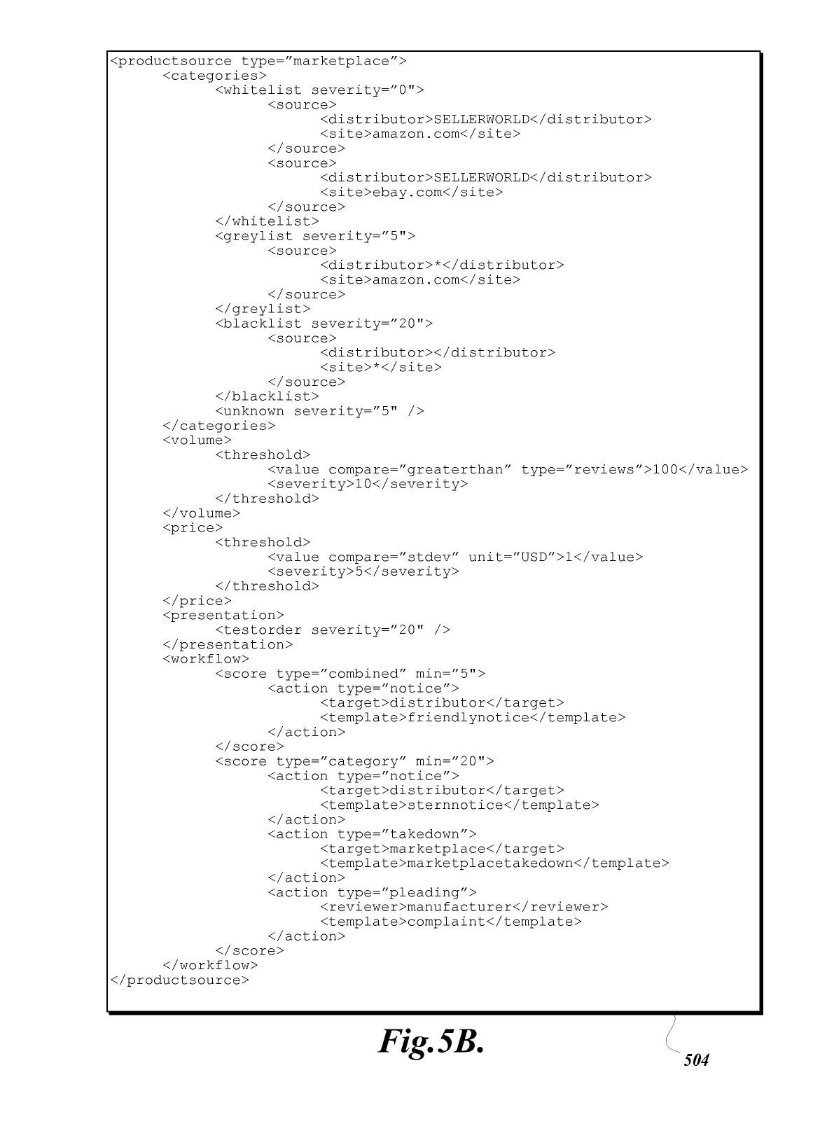

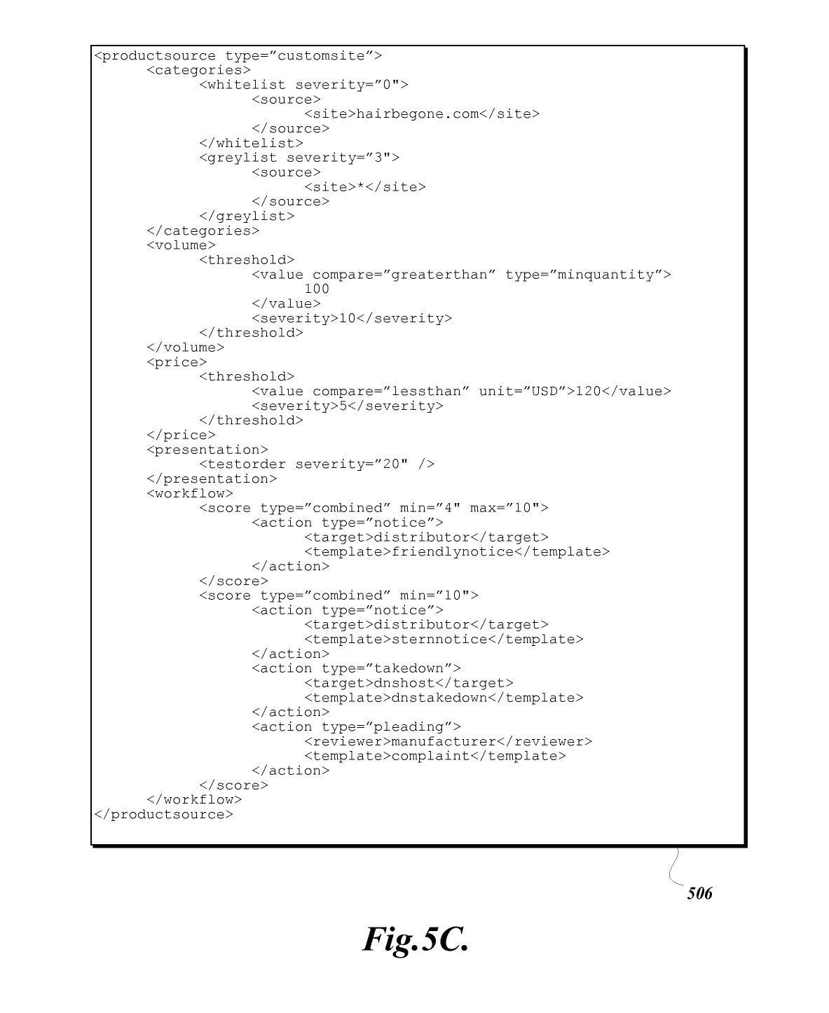

FIGS. 5A-5C illustrate portions of an exemplary product definition usable by various components of the communication protection system 200, according to various aspects of the present disclosure. The product definitions relate to an exemplary product, “HairBeGone,” a beauty supply device that is used for hair removal, and that is marketed and sold to the public via various channels. The “HairBeGone” is produced by a single manufacturer, so all authorized distributors and resellers should be known to the manufacturer, and should be selling the HairBeGone product as agreed with the manufacturer. One of ordinary skill in the art will recognize that the contents of the product definition have been illustrated as XML-formatted text for ease of discussion. In some embodiments, the contents of the product definition may be stored in a less human-accessible format, such as a serialized data structure, one or more database entries, and/or any other suitable format.

FIG. 5A illustrates a portion of an exemplary product definition 502 for analyzing B2B information resources 102 found to be offering the HairBeGone for sale. B2B information resources may be ripe for illicit sales or other unauthorized communication relating to the HairBeGone product. Often, known distributors from other parts of the world, who can obtain goods cheaper than sources in the United States, may seek to distribute their goods within the U.S. via resellers without informing the manufacturer. B2B information resources 102 may also be a common outlet for sales of counterfeit or knock-off products. Normally, this counterfeiting activity is very difficult for manufacturers to learn about.

As illustrated, the product definition 502 includes information for analyzing a product source on a B2B information resource 102 that includes categories, volume thresholds, price thresholds, and presentation thresholds. Upon the creation of a source profile, the various analysis components of the communication protection system 200 may use corresponding portions of the product definition 502 to analyze the source profile. One of ordinary skill in the art will recognize that the use of XML (or any other configurable data representation) to define the thresholds may allow a variety of different types of comparisons to be used in order to trigger the thresholds. The specification of severities within the XML representation allows different elements to be given differing amounts of weight. For example, violating a volume threshold may cause a harsher response than violating a price or presentation threshold due to a greater severity value, and/or the like. One of ordinary skill in the art will recognize that, in some embodiments, severities may be calculated based on more than one test and/or may be dynamically determined instead of being specified directly in the product definition.

In the illustrated embodiment, the category element includes a whitelist element that indicates that the SELLERWORLD distributor is expected to use the B2B information resources Alibaba.com and Made-in-China.com, and the SuperSource distributor is expected to use the B2B information resource Alibaba.com. If an analyzed product source matches either of these elements, the profile categorization engine 218 will categorize the product source as belonging to the whitelist. Otherwise, the profile categorization engine 218 may assign the product source to a more suspicious “unknown” category.

The magnitude evaluation engine 214 may use the threshold elements contained within the volume element as settings for determining the magnitude assessment score. As illustrated, the magnitude evaluation engine 214 may assign a magnitude assessment score of “5” if it is determined that a minimum purchase quantity is greater than a value of “25,” otherwise, the magnitude assessment score may remain at “0.” This configuration may allow low volume sources to be ignored by the communication protection system 200 in order to focus enforcement efforts on higher volume sources. The use of a severity element to provide the value for the magnitude assessment score may allow the weight given to failure of any particular threshold to be configurable on a case-by-case basis.

The price evaluation engine 210 may use the threshold elements contained within the price element as settings for determining the pricing assessment score. As illustrated, the price listed in the product source is compared to a suggested retail price of $250. If the price listed in the product source is less than the suggested retail price, the threshold is triggered and a pricing assessment score may be set to the value indicated in the severity element. The low price may indicate an attempt to undercut legitimate product sources, and therefore warrants further attention.

The presentation evaluation engine 220 may use the check for elements contained within the presentation element as settings for determining features to check for within the presentation of the product by the product source. As illustrated, the check for elements instruct the presentation evaluation engine 220 to check the product source for the presence of a product image that is smaller than 32px by 32px, and the presence of a tagline. If either element is missing, the presentation evaluation engine 220 may increment the product presentation score by the amount indicated in the corresponding severity element. As illegitimate sources are more likely to be in conflict with branding guidelines established by the manufacturer, failing to include these expected elements may indicate that a product source warrants further attention.

The automated remediation engine 222 may use the workflow element as settings for determining when to add particular actions to a workflow. As illustrated, the workflow element includes several score elements. The score elements specify score ranges within which a combined threat assessment score (a combination of the category threat value, the magnitude assessment score, the pricing assessment score, and the presentation assessment score) should fall for action elements included within the score elements to be processed. As illustrated, the elements cause an action to be added to the workflow to send a friendly notice to the distributor upon determining a low combined threat assessment score. The friendly notice may simply warn the distributor that further violations of the manufacturer's intellectual property rights and/or distribution rights will not be tolerated. In many cases, such a warning may be sufficient to curtail the unwanted activity. Upon determining a higher combined threat assessment score, the elements cause three actions to be added to the workflow: the sending of a stern notice to the distributor, the sending of a takedown notice to the B2B information resource 202, and the generation of a pleading for review by the manufacturer, the manufacturer's legal counsel, or another user acting on the manufacturer's behalf. These harsher actions may be chosen to take advantage of all possible options to stop the harmful activity. In other embodiments, the score elements may specify score ranges in different ways, or may specify individual assessment scores as a triggering element.

FIG. 5B illustrates a portion of an exemplary product definition 504 for analyzing a marketplace web site 104 found to be offering the HairBeGone for sale. Marketplace web sites 104 are also ripe for grey market or black market product distribution or other unauthorized communication, because the marketplace web sites 104 allow distribution directly to retail customers instead of through middlemen. While the ultimate source of products distributed through marketplace web sites 104 is generally unknown, the distributor is often identifiable, and so the communication protection system 200 may be able to contact the distributor directly upon the discovery of questionable offers for sale.

The product definition portion 504 is similar to the product definition 502 illustrated in FIG. 5A, but is adapted to monitor activity on marketplace web sites 104. While certain differences between the product definition portion 504 and the product definition portion 502 are described below, other differences in information and functionality may exist between the two product definitions that have not been described in detail for the sake of brevity. Such differences would be easily understood from the drawings by one of ordinary skill in the art.

Instead of only a whitelist category, the product definition 502 includes a greylist category and a blacklist category. The whitelist category indicates two sources that are known to be legitimate: the distributor SELLERWORLD offering the product through Amazon.com, and the distributor SELLERWORLD offering the product through eBay. The greylist category indicates that any product source with an identified distributor (other than SELLERWORLD) found to be distributing the product on Amazon.com is added to the greylist. The blacklist category indicates that any product source with an unidentified distributor on any site is added to the blacklist, as the attempt to hide the distributor is likely to indicate the presence of fraud. An unknown category is also specified for product sources that are on marketplace web sites 104 but that don't fall into any of the other categories.

The volume threshold and price threshold are similar to those illustrated and described above in FIG. 5A, though they show additional features. For example, the volume threshold in the product definition 504 instructs the magnitude evaluation engine 214 to consider the number of product reviews available on the marketplace web site 104, as opposed to the minimum order size. As another example, instead of setting a hard price limit, the price threshold instructs the price evaluation engine 210 to compare the price to an average of prices for the product, and to trigger the threshold if the price is greater than one standard deviation from the average.

The presentation threshold in the product definition 504 also shows an additional feature. The test order element indicates that the presentation evaluation engine 220 should cause an order for the product to be placed through the product source. This may include manual interaction with an interface provided by the user interface engine 224 once the ordered product is received in order to complete the analysis of the presentation evaluation engine 220. If the received product is determined to be a counterfeit or knock-off, the test order element may cause the associated severity to be incorporated into the presentation assessment score.

The workflow element in the product definition 504 is similar to that illustrated and described with respect to FIG. 5A. One example of a difference is that if a category score indicates that the product source has been assigned to the blacklist category, harsher actions may be added to the workflow regardless of the value of any other assessment score.

FIG. 5C illustrates a portion of an exemplary product definition 506 for analyzing a custom retail web site 106 found to be offering the HairBeGone for sale. Custom retail web sites 106 may be a particularly difficult form of product source to fight, due to their transient nature. However, the communication protection system 200 is likely to be able to automatically find such product sources shortly after they are made accessible to the public via search engines, and can take automated steps to shut them down.

The product definition portion 506 is again similar to the product definition portions 502, 504 illustrated and described above, but is adapted to monitor activity on custom retail web sites 106. While certain differences between the product definition portion 506 and the product definition portions 502, 504 are described below, other differences in information and functionality may exist between the product definitions that have not been described in detail for the sake of brevity. Such differences would be easily understood from the drawings by one of ordinary skill in the art.

The category element of the product definition portion 506 indicates only a single legitimate web site source for presence in the whitelist category. Any other custom retail web site 106 is assigned to the greylist category. When comparing the severity assigned to the greylist category to the thresholds for the workflow scores, one will notice that being assigned to the greylist alone is insufficient to trigger the workflow. Instead, another scoring threshold would have to be crossed in order to trigger the workflow. This may help avoid taking action against custom retail web sites 106 that are not actually offering the product for sale, or are offering the product for sale in an authorized manner but have been inadvertently omitted from the whitelist.

One of ordinary skill in the art will recognize that the product definition portions illustrated in FIGS. 5A-5C are exemplary only, and that product definitions with other values or for other types of information resources may be used. In some embodiments, each of the exemplary product definition portions illustrated and described above may be combined into a single product definition, such that the communication protection system 200 may analyze multiple types of information resources for the same product. In some embodiments, gathered resources that are associated with a product but that do not match any of the types of product definitions (such as a comparison shopping web site 110 found to be offering the HairBeGone, if the product definitions illustrated in FIGS. 5A-5C are the only product definition portions for the HairBeGone) may be treated as unexpected product sources, and may be flagged for additional review.

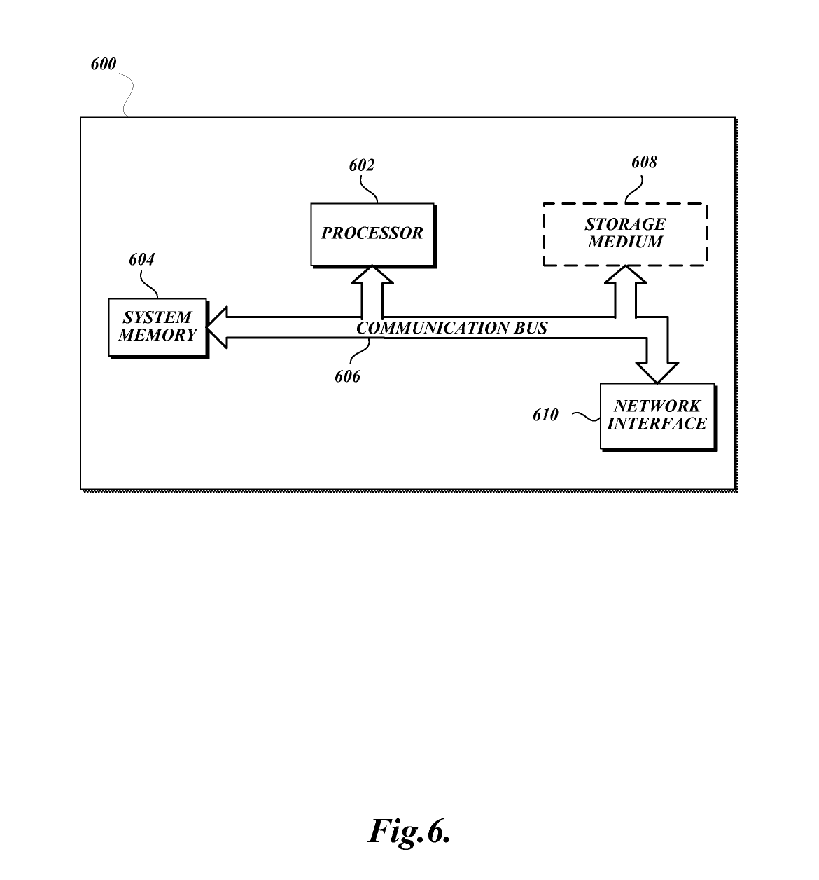

FIG. 6 illustrates aspects of an exemplary computing device 600 appropriate for use with embodiments of the present disclosure. While FIG. 6 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 600 may be any one of any number of currently available or yet to be developed devices.

In its most basic configuration, the computing device 600 includes at least one processor 602 and a system memory 604 connected by a communication bus 606. Depending on the exact configuration and type of device, the system memory 604 may include volatile or nonvolatile memory, such as read only memory (“ROM”), random access memory (“RAM”), EEPROM, flash memory, or similar memory technology. Those of ordinary skill in the art and others will recognize that system memory 604 typically stores data and/or program modules that are immediately accessible to and/or currently being operated on by the processor 602. In this regard, the processor 602 may serve as a computational center of the computing device 600 by supporting the execution of instructions.

As further illustrated in FIG. 6, the computing device 600 may include a network interface 610 comprising one or more components for communicating with other devices over a network. Embodiments of the present disclosure may access basic services that utilize the network interface 610 to perform communications using common network protocols such as TCP/IP, UDP, Ethernet, Token Ring, and/or the like. The network interface 610 may also include a wireless network interface configured to communicate via one or more wireless communication protocols, such as WiFi, 2G, 3G, LTE, WiMAX, Bluetooth, and/or the like.

In the exemplary embodiment depicted in FIG. 6, the computing device 600 also includes a storage medium 608. However, services may be accessed using a computing device that does not include means for persisting data to a local storage medium. Therefore, the storage medium 608 depicted in FIG. 6 is represented with a dashed line to indicate that the storage medium 608 is optional. In any event, the storage medium 608 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 604 and storage medium 608 depicted in FIG. 6 are merely examples of computer-readable media.

Suitable implementations of computing devices that include a processor 602, system memory 604, communication bus 606, storage medium 608, and network interface 610 are known and commercially available. For ease of illustration and because it is not important for an understanding of the claimed subject matter, FIG. 6 does not show some of the typical components of many computing devices. In this regard, the computing device 600 may include input devices, such as a keyboard, keypad, mouse, microphone, touch input device, touch screen, tablet, and/or the like. Such input devices may be coupled to the computing device 600 by wired or wireless connections including RF, infrared, serial, parallel, Bluetooth, USB, or other suitable connections protocols using wireless or physical connections. Similarly, the computing device 600 may also include output devices such as a display, speakers, printer, etc. Since these devices are well known in the art, they are not illustrated or described further herein.

While illustrative embodiments have been illustrated and described, it will be appreciated that various changes can be made therein without departing from the spirit and scope of the claims.

The embodiments of the invention in which an exclusive property or privilege is claimed are defined as follows:

1. A computer-implemented method for detecting and eliminating unauthorized digital communications, the method comprising:
building source profiles associated with a plurality of product sources, wherein building source profiles associated with a plurality of product sources comprises:
generating a set of search queries based on a set of product definitions;
executing the set of search queries to obtain a set of gathered resources;
creating a set of source profiles based on the set of gathered resources; and
updating the set of source profiles with information retrieved from the set of gathered resources using a set of parsing rules;
determining whether one or more aspects of a source profile of the set of source profiles exceed one or more predetermined remediation thresholds by calculating a presentation assessment score based on a comparison of brand information presented in the set of gathered resources used to create the source profile to brand information presentation guidelines identified in a product definition used to create the source profile; and
in response to determining that one or more aspects of the source profile exceed one or more predetermined remediation thresholds:
creating a remediation workflow having one or more remediation steps; and
executing the remediation steps of the remediation workflow.

2. The method of claim 1, wherein the brand information presentation guidelines include a specification of one or more of an approved image, a tagline, a trademark, a spelling check, a font, and a color.

3. The method of claim 1, wherein the method further comprises:
for the source profile of the set of source profiles:
calculating one or more of a category, a pricing assessment score, a magnitude assessment score, and a combined threat assessment score; and
wherein determining that one or more aspects of the source profile exceed one or more predetermined remediation thresholds includes determining that one or more of the category, the pricing assessment score, the magnitude assessment score, the presentation assessment score, or the channel protection score exceeds one or more predetermined remediation thresholds.

4. The method of claim 3, wherein calculating the pricing assessment score comprises comparing pricing information associated with the source profile to an expected pricing value.

5. The method of claim 3, wherein calculating the magnitude assessment score comprises comparing information indicative of sales volume associated with the source profile to a threshold volume value.

6. The method of claim 3, wherein calculating the presentation assessment score comprises causing brand information presented in gathered resources associated with the source profile to be presented to a manufacturer for manual review.

7. The method of claim 3, wherein calculating the category comprises assigning the source profile to a whitelist category, a greylist category, a blacklist category, or an unknown category based on information indicative of a product source associated with the source profile.

8. The method of claim 3, wherein calculating the combined threat assessment score comprises performing a calculation based on one or more of the pricing assessment score, the magnitude assessment score, the presentation assessment score, and the category associated with the source profile.

9. The method of claim 1, wherein the one or more remediation steps of the remediation workflow include one or more of:
automatically sending a notification to a manufacturer of a monitored product;
automatically sending a notification to the product source requesting cessation of illicit activity; and
automatically generating a legal document for review by a manufacturer of a monitored product.

10. A system for detecting and eliminating unauthorized digital communications, the system comprising at least one computing device configured to:
build source profiles associated with a plurality of product sources, wherein building source profiles associated with a plurality of product sources comprises:
generating a set of search queries based on a set of product definitions;
executing the set of search queries to obtain a set of gathered resources;
creating a set of source profiles based on the set of gathered resources; and
updating the set of source profiles with information retrieved from the set of gathered resources using a set of parsing rules;
determine whether one or more aspects of a source profile of the set of source profiles exceed one or more predetermined remediation thresholds by calculating a presentation assessment score based on a comparison of brand information presented in the set of gathered resources used to create the source profile to brand information presentation guidelines identified in a product definition used to create the source profile; and
in response to determining that one or more aspects of the source profile exceed one or more predetermined remediation thresholds:
create a remediation workflow having one or more remediation steps; and
execute the remediation steps of the remediation workflow.

11. The system of claim 10, wherein the brand information presentation guidelines include a specification of one or more of an approved image, a tagline, a trademark, a spelling check, a font, and a color.

12. The system of claim 10, wherein the one or more computing devices are further configured to:
for the source profile of the set of source profiles:
calculate one or more of a category, a pricing assessment score, a magnitude assessment score, and a combined threat assessment score; and
wherein determining that one or more aspects of the source profile exceed one or more predetermined remediation thresholds includes determining that one or more of the category, the pricing assessment score, the magnitude assessment score, the presentation assessment score, or the channel protection score exceeds one or more predetermined remediation thresholds.

13. The system of claim 12, wherein calculating the pricing assessment score comprises comparing pricing information associated with the source profile to an expected pricing value.

14. The system of claim 12, wherein calculating the magnitude assessment score comprises comparing information indicative of sales volume associated with the source profile to a threshold volume value.

15. The system of claim 12, wherein calculating the presentation assessment score comprises causing brand information presented in gathered resources associated with the source profile to be presented to a manufacturer for manual review.

16. The system of claim 12, wherein calculating the category comprises assigning the source profile to a whitelist category, a greylist category, a blacklist category, or an unknown category based on information indicative of a product source associated with the source profile.

17. The system of claim 12, wherein calculating the combined threat assessment score comprises performing a calculation based on one or more of the pricing assessment score, the magnitude assessment score, the presentation assessment score, and the category associated with the source profile.

18. The system of claim 10, wherein the one or more remediation steps of the remediation workflow include one or more of:
automatically sending a notification to a manufacturer of a monitored product;
automatically sending a notification to the product source requesting cessation of illicit activity; and
automatically generating a legal document for review by a manufacturer of a monitored product.

19. A non-transitory computer-readable medium having computer-executable instructions stored thereon that, in response to execution by one or more processors of one or more computing devices, cause the one or more computing devices to perform actions for detecting and eliminating unauthorized digital communications, the actions comprising:
building source profiles associated with a plurality of product sources, wherein building source profiles associated with a plurality of product sources comprises:
generating a set of search queries based on a set of product definitions;
executing the set of search queries to obtain a set of gathered resources;
creating a set of source profiles based on the set of gathered resources; and
updating the set of source profiles with information retrieved from the set of gathered resources using a set of parsing rules;
determining whether one or more aspects of a source profile of the set of source profiles exceed one or more predetermined remediation thresholds by calculating a presentation assessment score based on a comparison of brand information presented in the set of gathered resources used to create the source profile to brand information presentation guidelines identified in a product definition used to create the source profile; and
in response to determining that one or more aspects of the source profile exceed one or more predetermined remediation thresholds:
creating a remediation workflow having one or more remediation steps; and
executing the remediation steps of the remediation workflow.

20. The computer-readable medium of claim 19, wherein the brand information presentation guidelines include a specification of one or more of an approved image, a tagline, a trademark, a spelling check, a font, and a color.
